(19) United States
(12) Patent Application Publication
(10) Pub. No.: US 2018/0338530 A1
(43) Pub. Date: Nov. 29, 2018

(54) SYSTEMS INVOLVING VAPOR-PRODUCING DEVICES

(71) Applicant: David Wallace, Petrolia, CA (US)

(72) Inventor: David Wallace, Petrolia, CA (US)

(21) Appl. No.: 15/985,952

(22) Filed: May 22, 2018

Related U.S. Application Data
(60) Provisional application No. 62/510,101, filed on May 23, 2017.

(51) Int. Cl. A24F 47/00; A24F 15/18; H02J 7/00

(52) U.S. Cl. CPC A24F 47/008; H02J 7/0054; H02J 7/0044; A24F 15/18

(57) ABSTRACT

A representative system for dispensing liquid vapor to a user includes: a vapor-producing device having a vaporizer, a vapor outlet, a vapor identification system, and a liquid cartridge receptacle, the liquid cartridge receptacle being configured to receive a liquid cartridge, the liquid cartridge being configured to contain a dispensable liquid, the liquid cartridge having identification information configured to identify the liquid contained therein, the vaporizer being configured to selectively vaporize an amount of liquid from the liquid cartridge coupled to the receptacle and deliver a corresponding dose of vaporized liquid to the vapor outlet for inhalation by the user, and the vapor identification system being configured to determine the identification information corresponding to the liquid cartridge coupled to the receptacle and communicate the identification information of the liquid cartridge to a mobile device.

### CROSS REFERENCE TO RELATED APPLICATION

This utility patent application claims the benefit of and priority to U.S. Provisional Application 62/510,101, filed on 23 May 2018, which is incorporated by reference herein in its entirety.

### BACKGROUND

### Technical Field

The present disclosure generally relates to vapor-producing devices.

### Description of the Related Art

The popularity of vapor-producing devices (e.g., e-cigarettes) has increased dramatically in recent years. In an effort to promote user convenience, various technologies have been adopted for combining vapor-producing devices with mobile devices. By way of example, U.S. Pat. No. 9,668,518 to Esses involves technologies effective to receive a battery of an electronic cigarette in a mobile device case. A mobile device may be received in a first portion of the mobile device case in such a way that the mobile device is accessible to a user. The battery of the electronic cigarette may be received in a compartment of a second portion of the mobile device case. The compartment may be formed by one or more walls of the mobile device case. The first portion of the mobile device case may be contiguous with the second portion of the mobile device case.

Additionally, U.S. Pat. No. 9,197,726 to Stanimirovic involves a mobile phone case comprising: a protective case element designed for coupling to a mobile phone via a fiction fit; a mobile phone power port for conductively coupling the case element with the mobile phone; a housing embedded within the case element; a rechargeable battery located within the housing and conductively coupled to the mobile phone power port; an external power port conductively coupled to the battery, the external power port for accepting power so as to recharge the battery; an electronic cigarette element embedded within the housing and comprising a heating element, conductively coupled to the battery, for heating a liquid into a vapor and a tubular element designed to allow a user to suck said vapor through said tubular element; and a processor configured for routing power from the battery to the mobile phone power port and to the heating element of the electronic cigarette element.

Although adequate for solving various needs, there exists a desire for improvements that that the prior art has been unable to address.

### SUMMARY

Briefly described, one embodiment, among others, is a system for dispensing liquid vapor to a user that includes: a vapor-producing device having a vaporizer, a vapor outlet, a vapor identification system, and a liquid cartridge receptacle, the liquid cartridge receptacle being configured to receive a liquid cartridge, the liquid cartridge being configured to contain a dispensable liquid, the liquid cartridge having identification information configured to identify the liquid contained therein, the vaporizer being configured to selectively vaporize an amount of liquid from the liquid cartridge coupled to the receptacle and deliver a corresponding dose of vaporized liquid to the vapor outlet for inhalation by the user, and the vapor identification system being configured to determine the identification information corresponding to the liquid cartridge coupled to the receptacle and communicate the identification information of the liquid cartridge to a mobile device.

Another embodiment, among others, is a system for dispensing liquid vapor to a user that includes: a vapor-producing device having a receptacle configured to receive a cartridge containing a vaporizable substance, a heating element configured to heat the vaporizable substance to create a vapor, and a tip configured to convey the vapor to a user; and a vapor network system configured to receive identification information associated with the cartridge from the vapor-producing device, and facilitate interaction of the user with a website in which the user is identified as a user of the substance contained in the cartridge.

Other systems, methods, features, and advantages of the present disclosure will be or may become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram of an example embodiment of a system for dispensing liquid vapor to a user.

FIG. 2 is a flowchart depicting functionality associated with an example embodiment of a vapor identification system.

FIG. 3 is a schematic diagram of another example embodiment of a system for dispensing liquid vapor to a user.

FIG. 4 is a schematic diagram of another example embodiment of a system for dispensing liquid vapor to a user.

FIG. 5 is a schematic diagram of another example embodiment of a system for dispensing liquid vapor to a user.

FIG. 6 is a flowchart depicting functionality associated with an example embodiment of a vapor network system.

FIG. 7 is a flowchart depicting functionality associated with an example embodiment of a social media system.

FIG. 8 is a flowchart depicting functionality associated with another example embodiment of a social media system.

FIG. 9 is a schematic diagram of another example embodiment of a system for dispensing liquid vapor to a user.

### DETAILED DESCRIPTION

Having summarized various aspects of the present disclosure, reference will now be made in detail to that which is illustrated in the drawings. While the disclosure will be described in connection with these drawings, there is no intent to limit the scope of legal protection to the embodiment or embodiments disclosed herein. Rather, the intent is to cover all alternatives, modifications and equivalents included within the spirit and scope of the disclosure as defined by the appended claims.

Systems and methods are provided that involve producing liquid vapor for dispensing to a user. In some embodiments, a liquid cartridge is provided that, in addition to containing a dispensable liquid, includes identification (ID) information configured to identify the liquid. A vapor-producing device, which is configured to selectively vaporize an amount of the liquid from the liquid cartridge, incorporates a vapor identification system that is configured to determine the ID information corresponding to the liquid cartridge and communicate the ID information to a mobile device. The ID may then be used to facilitate interaction of the user with a website. In some embodiments, interaction with such a website may involve posting comments related to the dispensed liquid and/or placing orders for more liquid cartridges, among others.

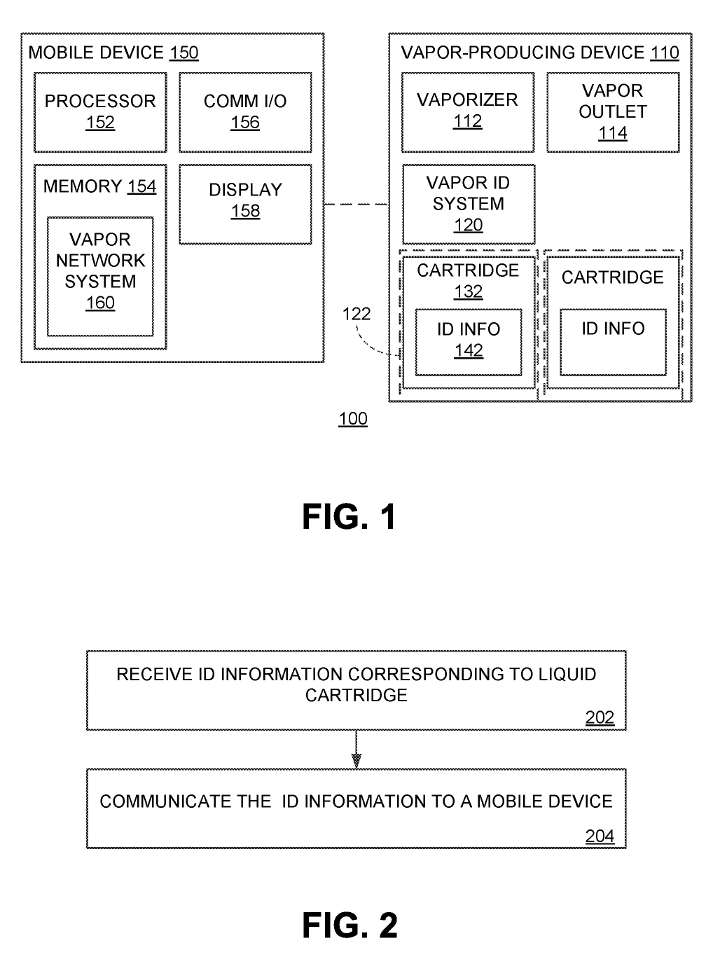

An embodiment of a system for dispensing liquid vapor to a user will now be described. In this regard, system 100 of FIG. 1 incorporates a vapor-producing device 110 that includes a vaporizer 112, a vapor outlet 114, a vapor identification system 120, and a liquid cartridge receptacle 122. Liquid cartridge receptacle 122 is configured to receive a liquid cartridge (e.g., liquid cartridge 132), which is configured to contain a dispensable liquid. Liquid cartridge 132 also includes ID information configured to identify the dispensable liquid (e.g., oil). Various configurations of ID information may be used, such as barcode and RFID, among others.

Vapor identification system 120 is configured to determine the ID information corresponding to any liquid cartridges mounted to vapor-producing device 110. In particular, vapor identification system 120 is configured to determine the ID information with a technology compatible to the format of the ID information being use. By way of example, in embodiments in which the ID information is provided as a barcode, vapor identification system 120 is configured as a barcode reader. Vapor identification system 120 also is configured to communicate the ID information to a mobile device (e.g., mobile device 150).

Vaporizer 112 is configured to selectively vaporize an amount of liquid from one or more of the liquid cartridges mounted to vapor-producing device 110 so that a corresponding dose of vaporized liquid is delivered via vapor outlet 114 for inhalation by a user. In some embodiments, vapor identification system 120 receives one or more additional types of information associated with operation of vapor-producing device 110 and/or any associated liquid cartridges. By way of example, in some embodiments, vapor identification system 120 may receive information regarding one or more of: type of substance in the cartridge; quality of the substance; a current fill level of a liquid cartridge; a number of doses provided from a cartridge; and, a number of doses remaining.

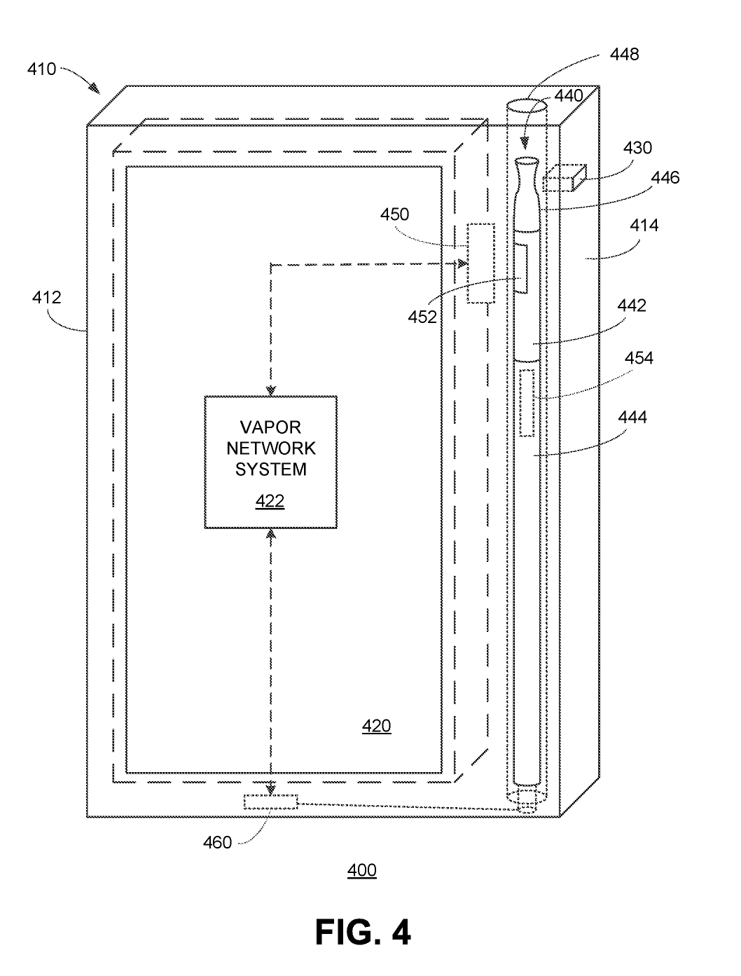

In some embodiments, vapor-producing device 110 may be configured as a stand-alone wand (such as described in relation to vapor-producing device 440 of the embodiment of FIG. 4). In such an embodiment, the wand may incorporate one or more components to facilitate communication with an associated mobile device (or other device that implements a vapor network system). By way of example, the wand may incorporate a Bluetooth transceiver configured to communicate ID information of a cartridge to the vapor network system.

As shown in FIG. 1, system 100 also incorporates a mobile device 150 (e.g., a smart phone). Mobile device 150 includes a processor 152, a memory 154, a communication interface 156, and a display 158. Memory 154 incorporates a vapor network system 160, which include processor-executable instructions, configured to receive the identification information. In some embodiments, as will be described in greater detail later, vapor network system 160 may facilitate interaction of the user of mobile device 150 with a website in which the user is identified as a user of the liquid contained in liquid cartridge 132.

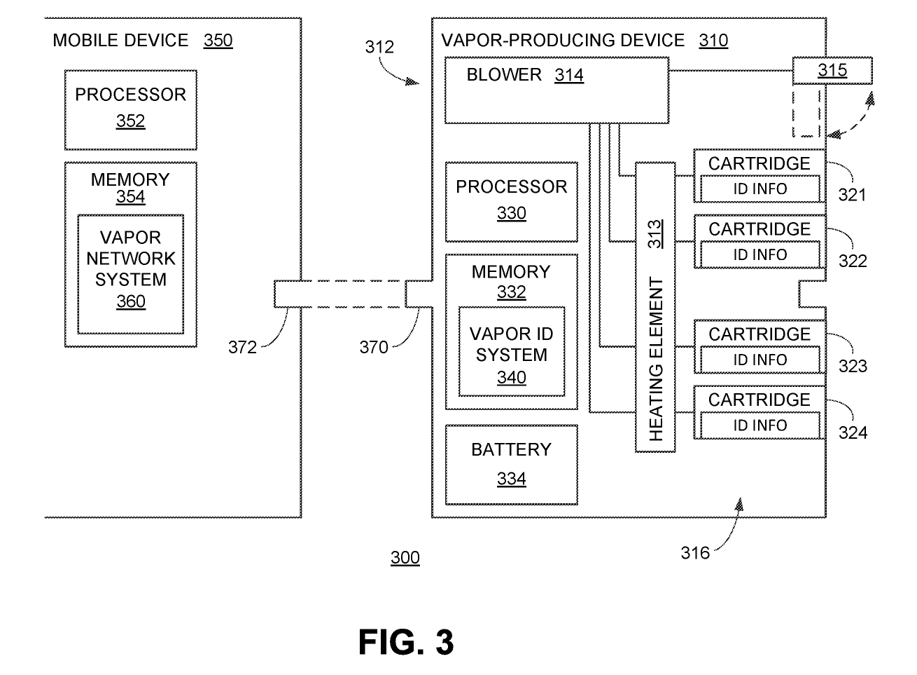

FIG. 2 is a flowchart depicting functionality (or method) associated with an example embodiment of a vapor identification system, such as vapor identification system 120 of FIG. 1. As shown in FIG. 2, the functionality includes receiving ID information corresponding to a liquid cartridge (block 202). In block 204, the ID information is communicated to a mobile device. In some embodiments, such as described in relation to FIG. 3, for example, the mobile device to which the ID information is communicated may be attached to a vapor-producing device that includes the vapor identification system.

FIG. 3 is a schematic diagram of another example embodiment of a system for dispensing liquid vapor to a user. As shown in FIG. 3, system 300 incorporates a vapor-producing device 310 that includes a vaporizer 312. Vaporizer 312 includes a heating element 313 and a blower 314. An extendable tip 315 communicates with blower 314 to receive vapor provided by the blower and through which the vapor can be inhaled.

A reservoir portion 316 is also included. Reservoir portion 310 is configured to hold a vaporizable substance, such as oil infused with an active chemical which, when inhaled, may provide an effect on a user's bodily function. In this embodiment, reservoir portion 316 is configured to mount multiple cartridges containing such substances (e.g., cartridges 321-324). Each of the cartridge 321-324 includes ID information configured to identify the dispensable liquid contained therein.

Vapor-producing device 310 additionally includes a processor 330, memory 332, and a battery 334. A vapor identification system 340 is stored in memory 332 and is configured to determine the ID information corresponding to any liquid cartridges mounted to vapor-producing device 310. Vapor identification system 340 also is configured to communicate the ID information to a mobile device (e.g., mobile device 350).

Mobile device 350 includes a processor 352 and a memory 354, which incorporates a vapor network system 360. In some embodiments, vapor network system 360 is configured to display information about a substance contained by one or more of the cartridges on the screen of mobile device 350 based on information received from vapor identification system 340.

It should be noted that, in the embodiment of FIG. 3, mobile device 350 and vapor-producing device 310 are configured to detachably connect to each other, such as via corresponding mating connectors 370, 372.

FIG. 4 is a schematic diagram of another example embodiment of a system for dispensing liquid vapor to a user. In contrast to the previous embodiments, this one accommodates removal of the vapor-producing device from other components of the system so that it may be used separately. As shown in FIG. 4, system 400 incorporates a case 410 that is configured to be mounted to a mobile device 420, which incorporates a vapor network system 422. Case 410 includes a frame portion 412 that is configured to receive mobile device 420, and which may offer various protections (e.g., shock resistance) for the mobile device. A vapor portion 414 also is provided. In this embodiment, vapor portion 414 is aligned with a longer side of mobile device 420, although other configurations may be used.

Vapor portion 414 includes a receptacle 430 that is sized and shaped to receive vapor-producing device 440, which is configured as a removable wand. Vapor-producing device 440 incorporates a liquid cartridge 442, a vaporizer 444, and a mouth tip 446. Vaporizer 444 includes a battery, a heater, and a blower (not shown) for providing vapor to mouth tip 446 when desired. Vapor-producing device 440 may be inserted into receptacle 430 for stowage via an orifice 448 located along a side of case 410. Vapor-producing device 440 is secured in receptacle 430 by a latching mechanism that is configured to selectively secure and release vapor-producing device 440.

Vapor portion 414 also includes a reader 450 of a vapor identification system that is configured to determine the ID information 452 associated with liquid cartridge 442. A charger 460 also is provided for powering vapor-producing device 440. In this embodiment, vapor-producing device 440 and mobile device 420 use a charging circuit that enables simultaneous charging. As mentioned above, in some embodiments, vapor-producing device 440 may incorporate one or more communication components 454 for communicating information to vapor network system 422, thus potentially replacing and/or supplementing functionality provided by reader 450.

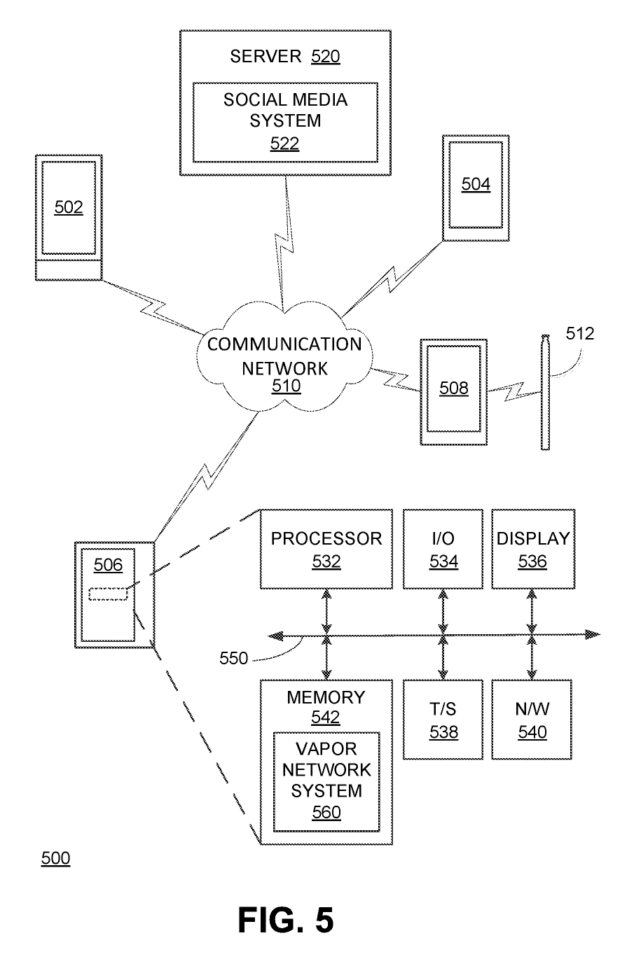

FIG. 5 is a schematic diagram of another example embodiment of a system for dispensing liquid vapor to a user. As shown in FIG. 5, system 500 includes mobile devices 502, 504, 506, and 508 communicatively coupled via a communication network 510 to a server 520, which hosts a social media system 522. Each of the mobile devices may be embodied as a mobile computing device such as, for example and without limitation, a smartphone that incorporates cellular telephone functionality. Notably, the communications network can use one or more of various communications types such as, for example and without limitation, cellular and Wi-Fi communications. Also note that mobile device 508 is configured to communicate with a stand-alone wand 512.

As described earlier, a mobile device (e.g., mobile device 506) will typically be embodied as a smartphone but may also be embodied in any one of a wide variety of wired and/or wireless computing devices. As shown in FIG. 5, mobile device 506 includes a processing device (processor) 532, input/output interfaces 534, a display 536, a touchscreen interface 538, a network interface 540, and a memory 542, with each communicating across a local data bus 550. Additionally, mobile device 506 incorporates a vapor network system 560, which may be stored on memory 542.

Processing device 532 may include any custom made or commercially available processor, a central processing unit (CPU) or an auxiliary processor among several processors associated with the mobile device 506, a semiconductor based microprocessor (in the form of a microchip), one or more application specific integrated circuits (ASICs), a plurality of suitably configured digital logic gates, and other electrical configurations comprising discrete elements both individually and in various combinations to coordinate the overall operation of the system.

Memory 542 can include any of a combination of volatile memory elements (e.g., random-access memory (RAM, such as DRAM, and SRAM, etc.)) and nonvolatile memory elements. Memory 542 typically comprises native operating system, one or more native applications, emulation systems, or emulated applications for any of a variety of operating systems and/or emulated hardware platforms, emulated operating systems, etc. For example, the applications may include application specific software which may comprise some or all the components of the mobile device 506. In accordance with such embodiments, the components are stored in memory and executed by the processing device.

One of ordinary skill in the art will appreciate that memory 542 can, and typically will, comprise other components which have been omitted for purposes of brevity. Note that in the context of this disclosure, a non-transitory computer-readable medium stores one or more programs for use by or in connection with an instruction execution system, apparatus, or device. Network interface 540 comprises various components used to transmit and/or receive data over a networked environment such as depicted in FIG. 5. When such components are embodied as an application, the one or more components may be stored on a non-transitory computer-readable medium and executed by the processing device.

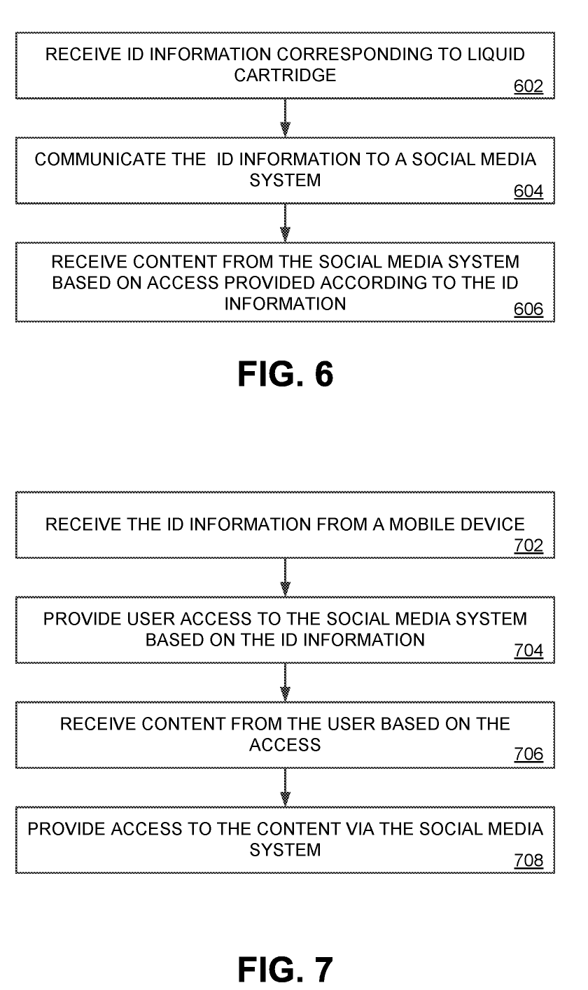

In operation, vapor network system 560 may perform various functionality, such as that shown in FIG. 6. In this regard, the functionality may be construed as beginning at block 602, in which ID information is received. In block 604, the ID information is communicated to a social media system. By way of example, a mobile device associated with the vapor network system (e.g., mobile device 506) may transmit the ID information via a communications network (e.g., network 508). Then, as depicted in block 604, content is received from the social media system based on access provided according to the ID information. In some embodiments, the content is provided by a website provided by the social network system that is hosted by an associated server. the social media system is further configured to:

In some embodiments, differentiation of access levels is provided. For instance, a first level of user access may be provided to a user that is not associated with ID identification information that corresponds to a liquid cartridge not affiliated with the social network system. However, a second level of user access may be provided to a user associated with ID information that corresponds to a liquid cartridge that is affiliated with the social network system. In this manner, the second level of user access permits the user to post content regarding the liquid cartridge because this user likely used the liquid cartridge and may be better suited to provide meaningful feedback.

In this regard, FIG. 7 is a flowchart depicting functionality associated with an example embodiment of a social media system. As shown in block 702, ID information is received from a mobile device. In some embodiments, the ID information may be one of various types of information required for enabling interaction with a social network system, such as username and password. In block 704, the user is provided with access to the social media system based on the ID information. Then, as shown in block 704, content is received from the user based on the access. By way of example, the content may be associated with a product review. In block 708, access to the content is provided (such as to other users) via the social network system. In some embodiments, this may be accomplished by posting the content to a website.

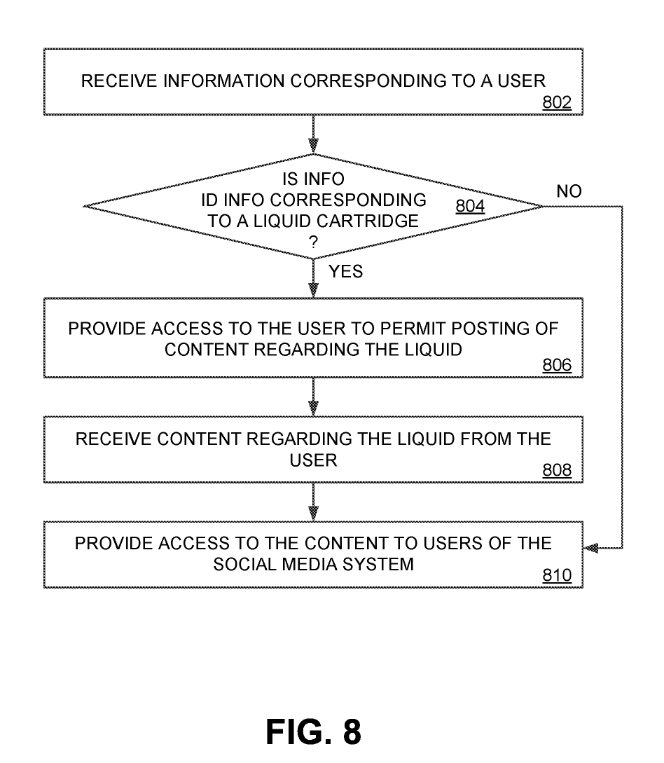

FIG. 8 is a flowchart depicting functionality associated with another example embodiment of a social media system. As shown in block 802, information corresponding to a user is received. In some embodiments, the information may be received from a mobile device. In block 804, a determination is made as to whether the information received is ID information corresponding to a liquid cartridge. If the information is ID information, the process may proceed to block 806, in which the user is provided with access to the social media system in order to post content regarding the liquid. In block 808, content regarding the liquid is received from the user. In block 810, access to the content is provided to users (e.g., all users) via the social network system. It should be noted that, in block 804, if it is determined that the received information is not ID information, the process may proceed directly from block 804 to block 810 to provide limited access (e.g., review of posted content).

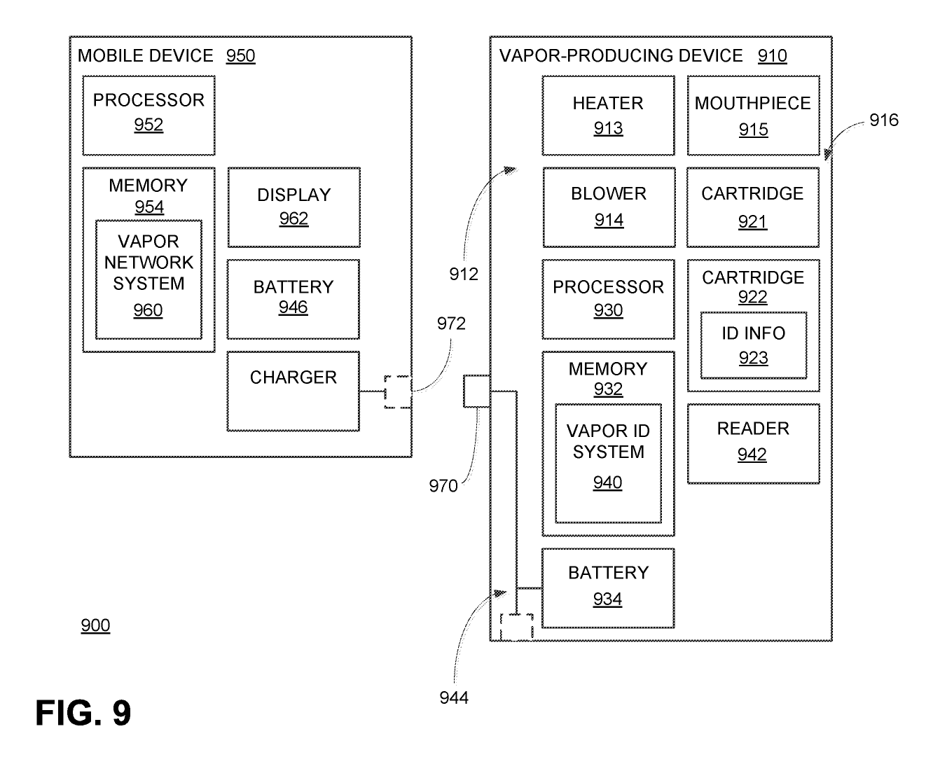

FIG. 9 is a schematic diagram of another example embodiment of a system for dispensing liquid vapor to a user. As shown in FIG. 9, system 900 incorporates a vapor-producing device 910 that includes a vaporizer 912, which includes a heating element 913 and a blower 914. A mouthpiece (e.g., tip) 915 communicates with blower 914 to receive vapor provided by the blower and through which the vapor can be inhaled.

A reservoir portion 916 is included that is configured to hold a vaporizable substance. In this embodiment, reservoir portion 916 is configured to mount multiple cartridges containing such substances (e.g., cartridges 921 and 922). Each of the cartridges includes ID information (e.g., ID Info 923) that is configured to identify the dispensable liquid contained therein.

Vapor-producing device 910 additionally includes a processor 930, memory 932, and a battery 934. A vapor identification (ID) system 940 is stored in memory 932 and is configured to determine the ID information corresponding to any liquid cartridges mounted to vapor-producing device 910. Vapor identification system 940 also is configured to communicate the ID information to a mobile device (e.g., mobile device 950).

Vapor-producing device 910 also includes a reader 942 that is configured to determine ID information associated with a liquid cartridge. A charger 944 (e.g., a charging circuit) also is provided for powering vapor-producing device 910. In this embodiment, charger 944 may facilitate simultaneous charging of a battery 934 and a battery 946 of an associated mobile device 950 (e.g., via an associated charger of the mobile device).

Mobile device 950 (e.g., a smart phone) includes, among other components which are not described here) a processor 952 and a memory 954, which incorporates a vapor network system 960. In some embodiments, vapor network system 960 is configured to display information about a substance contained by one or more of the cartridges via a display 962 of mobile device 950 based on information received from vapor identification system 940, among other information as may be provided by an associated social media system. It should be noted that, in the embodiment of FIG. 9, mobile device 950 and vapor-producing device 910 are configured to detachably connect to each other, such as via corresponding mating connectors 970 and 972.

If embodied in software, it should be noted that each block depicted in the flowcharts represents a module, segment, or portion of code that comprises program instructions stored on a non-transitory computer readable medium to implement the specified logical function(s). In this regard, the program instructions may be embodied in the form of source code that comprises statements written in a programming language or machine code that comprises numerical instructions recognizable by a suitable execution system. The machine code may be converted from the source code, etc. If embodied in hardware, each block may represent a circuit or a number of interconnected circuits to implement the specified logical function(s). Additionally, although the flowcharts show specific orders of execution, it is to be understood that the orders of execution may differ.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A system for dispensing liquid vapor to a user, the system comprising:
a vapor-producing device having a receptacle configured to receive a cartridge containing a vaporizable substance, a heating element configured to heat the vaporizable substance to create a vapor, and a tip configured to convey the vapor to a user; and
a vapor network system configured to receive identification information associated with the cartridge from the vapor-producing device, and facilitate interaction of the user with a website in which the user is identified as a user of the substance contained in the cartridge.

2. The system of claim 1, wherein the vapor-producing device has a vapor identification system configured to communicate the identification information associated with the cartridge to the vapor network system.

3. The system of claim 2, wherein the vapor network system is implemented in a mobile device.

4. The system of claim 3, further comprising a case configured to retain the mobile device.

5. The system of claim 4, wherein the case contains a heater battery separate from a battery of the mobile device.

6. The system of claim 4, wherein the vapor-producing device is removable from the case.

7. The system of claim 6, wherein the case has an orifice on an exterior of the case that communicates with a receptacle configured to removably receive the vapor-producing device.

8. The system of claim 1, wherein the case has a charging port and an associated charging circuit configured such that a charging current applied to the charging port charges the heater battery and a battery of the mobile device simultaneously.

9. The system of claim 1, wherein the cartridge includes the identification information as machine-readable data on an exterior of the cartridge.

10. A system for dispensing liquid vapor to a user, the system comprising:
a vapor-producing device having a vaporizer, a vapor outlet, a vapor identification system, and a liquid cartridge receptacle,
the liquid cartridge receptacle being configured to receive a liquid cartridge, the liquid cartridge being configured to contain a dispensable liquid, the liquid cartridge having identification information configured to identify the liquid contained therein, the vaporizer being configured to selectively vaporize an amount of liquid from the liquid cartridge coupled to the receptacle and deliver a corresponding dose of vaporized liquid to the vapor outlet for inhalation by the user, and
the vapor identification system being configured to determine the identification information corresponding to the liquid cartridge coupled to the receptacle and communicate the identification information of the liquid cartridge to a mobile device.

11. The system of claim 10, further comprising the mobile device, wherein the mobile device has a vapor network system configured to receive the identification information, and facilitate interaction of the user with a website in which the user is identified as a user of the liquid contained in the liquid cartridge.

12. The system of claim 11, further comprising a server configured to host the website.

13. The system of claim 12, wherein:
the mobile device has a processor; and
the vapor network system comprises processor-executable instructions configured to:
receive the identification information; and
communicate the identification information to the server.

14. The system of claim 12, wherein the website is provided by a social media system hosted by the server.

15. The system of claim 14, wherein the social media system comprises processor-executable instructions configured to:
receive the identification information; and
provide user access to the social media system based on the identification information.

16. The system of claim 15, wherein, to provide the user access, the social media system is further configured to:
permit a first level of user access to a user not associated the identification information and a second level of user access to a user associated the identification information such that the second level of user access permits the user to post content regarding the liquid cartridge associated with the identification information and the first level of user access does not permit the user to post content regarding the liquid cartridge.

17. The system of claim 10, wherein the vapor identification system comprises a reader configured to determine the identification information by optically scanning the liquid cartridge.

18. The system of claim 17, wherein the vapor identification system is further configured to determine a number of doses of vapor associated with the liquid cartridge.
